(19) United States
(12) Patent Application Publication
(10) Pub. No.: US 2014/0009724 A1
(43) Pub. Date: Jan. 9, 2014

(54) BLACKLIGHT MODULE AND CORRESPONDING LIQUID CRYSTAL DISPLAY DEVICE

(71) Applicants: Hu He, Guangdong (CN); Kuangyao Chang, Guangdong (CN); Weiyan Wei, Guangdong (CN)

(72) Inventors: Hu He, Guangdong (CN); Kuangyao Chang, Guangdong (CN); Weiyan Wei, Guangdong (CN)

(73) Assignee: SHENZHEN CHINA STAR OPTOELECTRONICS TECHNOLOGY CO., LTD., Guangdong (CN)

(21) Appl. No.: 13/701,792

(22) PCT Filed: Aug. 16, 2012
(86) PCT No.: PCT/CN2012/080262

§ 371 Date: Dec. 3, 2012

(30) Foreign Application Priority Data
Jul. 9, 2012 (CN) 201210235142.7

(51) Int. Cl. G02F 1/1335; F21V 8/00

(52) U.S. Cl. CPC G02F 1/133611; G02B 6/0033
USPC 349/65; 362/606

(57) ABSTRACT

A backlight module and its corresponding liquid crystal display device are disclosed. The backlight module has a light guide plate and an LED light source. The light guide plate has an incident surface, a light-outputting surface and two side surfaces. The light-outputting surface has a plurality of micro-structures formed thereon for converging lights. Each of the side surfaces has a light-absorption material mounted thereon for absorbing lights outputted from the side surfaces. The backlight module can reduce the crosstalk phenomenon of brightness.

### BACKGROUND OF THE INVENTION

1. Field of the Invention

The present invention relates to a backlight module, especially to a backlight module and a corresponding liquid crystal display that feature reduction on crosstalk.

2. Description of the Related Art

With the advancement of 3D techniques, liquid crystal display devices with 3D display function are becoming more and more popular. The present 3D display technologies of liquid crystal display device include a polarized 3D display technology and an active shutter 3D display technology, wherein the active shutter 3D display technology has better 3D display effect and is suitable for products like liquid crystal display devices, and is supported by many manufacturers.

When a liquid crystal display device using active shutter 3D display technology is working, the backlight module needs to provide backlights by regions in a scanning manner. That is, to orderly light up the regions and accordingly activates corresponding pixels of a display panel to achieve image display. As shown in FIG. 1 and FIG. 2, FIG. 1 is a schematic diagram of the structure of a conventional backlight module of a liquid crystal display device using an active shutter 3D display technology, and FIG. 2 is a cross-sectional view taken along the line A-A′ in FIG. 1. The backlight module includes a light guide plate 11 and an LED light source 12, wherein the LED light source 12 has a plurality of LEDs which are grouped into a first region 101, a second region 102, a third region 103 and a fourth region 104. When the LEDs of the LED light source 12 in the first region 101 are lit up, the LEDs of the LED light source 12 in other region are turned off, and in the meantime the pixels in the corresponding position in the display panel are driven to display; when the LEDs of the LED light source 12 are lit up, the LEDs of the LED light source 12 in the other regions are turned off, and in the meantime the pixels in another corresponding position in the display panel are driven to display; so do the LEDs of the LED light source 12 in the other regions, and every frame requires the foregoing operations to display images.

The display effect of active shutter 3D display is measured according to crosstalk between different regions. The less the crosstalk is, the better the display effect is. However the crosstalk between different regions is formed because the adjacent regions influence each other in brightness. The best display state of the liquid crystal display device is when the LEDs in one region are lit up, the LEDs in other regions are at dark state. Although a light guide plate that uses microstructures can converge lights to a propagation direction in a larger extent, but in fact the outputting lights of the LED light source still have certain divergence angles. With reference to FIG. 3, FIG. 3 is a schematic diagram of the brightness distribution of a backlight module of a conventional liquid crystal display device using active shutter 3D display technology. As shown in the figure, since the LEDs of the LED light source in each of the regions have certain divergence angles, when the LEDs of the LED light source in the first region 101 are lit up, a certain degree of light leakage occurs at an end of the light guide plate that is close to the fourth region 104 and far from LED light source. This light leakage is caused because the lights are reflected by the side of the light guide plate and scattered by dot patterns of the light guide plate.

With reference to FIG. 4, FIG. 4 is a curve diagram of brightness crosstalk of the backlight module of the conventional liquid crystal display device using active shutter 3D display technology, wherein a horizontal axis represents light-outputting positions on a light-outputting surface of the light guide plate along an X direction in FIG. 1, and the X direction is perpendicular to a light incident direction of the light guide plate; and a vertical axis represents the corresponding crosstalk rates at the light-outputting positions. It can be seen in the figure that the side of the light guide plate has the most serious crosstalk near a far end (wherein the position in which the most serious crosstalk occurs in the figure is at a distance of 1/9 of the length of the light guide plate from the far end, wherein the far end is the end far from the LED light source); the second most serious crosstalk is at the middle of the side of the light guide plate (which position in the figure is at a distance of ½ of the length of the light guide plate); and the side of the light guide plate has relatively less crosstalk near a close end (which position in the figure is at a distance of 1/9 of the length of the light guide plate from the close end, wherein the close end is the end close to the LED light source) while compared with the crosstalk near the far end. Since the degree of light leakage at the side of the light guide plate near the far end is more serious than near the close end; brightness crosstalk may easily occur at the side of the light guide plate.

Therefore, it is necessary to provide a backlight module and its corresponding liquid crystal display device to overcome the problems existing in the conventional technology.

### SUMMARY OF THE INVENTION

The main objective of the invention is to provide a backlight module, which has a simple structure, costs less and can greatly reduce brightness crosstalk, and a corresponding liquid crystal device so as to solve the technical problem in which the light guide plate of the conventional backlight module has serious light leakage near a far end at a side of the light guide plate and causes a serious brightness crosstalk at the side of the light guide plate.

In order to achieve the foregoing object of the present invention, the present invention provides technical solutions as below.

The present relates to a backlight module comprising:

a light guide plate having an incident surface, a light-outputting surface and two side surfaces, wherein the incident surface is perpendicular to the light-outputting surface, each of the side surfaces is perpendicular to the incident surface and the light-outputting surface, and the light-outputting surface has a plurality of micro-structures formed thereon for converging lights; and

an LED light source mounted beside the incident surface of the light guide plate and being divided into at least two regions, wherein LEDs of the LED light sources in each of the regions are used to output lights to the incident surface so as to provide backlight to the pixels in the corresponding positions of a display panel via the light guide plate; wherein

the micro-structures are a plurality of bar-shaped prisms, and the bar-shaped prisms are arranged parallel to each other, and each of the bar-shaped prisms has a length direction parallel to the side surfaces, and each of the side surfaces has a light-absorption adhesive tape or light-absorption printing ink being mounted thereon and near an end of the side surface far from the LED light source for absorbing lights outputted from the side surface.

In the backlight module of the present invention, the length of the side surface where the light-absorption adhesive tape or light-absorption printing ink is mounted occupies 10% to 50% of the total length of the side surface.

In the backlight module of the present invention, the length of the side surface where the light-absorption adhesive tape or light-absorption printing ink is mounted occupies 10% to 20% of the total length of the side surface.

The present invention further relates to another backlight module comprising:

a light guide plate having an incident surface, a light-outputting surface and two side surfaces, wherein the incident surface is perpendicular to the light-outputting surface, each of the side surfaces is perpendicular to the incident surface and the light-outputting surface, the light-outputting surface has a plurality of micro-structures formed thereon for converging lights, and each of the side surfaces has a light-absorption material mounted thereon for absorbing lights outputted from the side surfaces; and

an LED light source mounted beside the incident surface of the light guide plate and being divided into at least two regions, wherein LEDs of the LED light sources in each of the regions are used to output lights to the incident surface so as to provide backlight to pixels in the corresponding positions of a display panel via the light guide plate.

In the backlight module of the present invention, the micro-structure are a plurality of bar-shaped prisms; the bar-shaped prisms are arranged parallel to each other;

each of the bar-shaped prisms has a length direction parallel to the side surfaces; and the light-absorption material is mounted near an end of the side surface far from the LED light source.

In the backlight module of the present invention, the length of the side surface where the light-absorption material is mounted occupies 10% to 50% of the total length of the side surface.

In the backlight module of the present invention, the length of the side surface where the light-absorption material is mounted occupies 10% to 20% of the total length of the side surface.

In the backlight module of the present invention, the light-absorption material is a light-absorption adhesive tape.

In the backlight module of the present invention, the light-absorption material is light-absorption printing ink.

In the backlight module of the present invention, the light-absorption material is a light-absorption adhesive tape with light-absorption printing ink.

The present invention further relates to a liquid crystal display device comprising:

a display panel having a plurality of pixels for display images; and

a backlight module having:
a light guide plate having an incident surface, a light-outputting surface and two side surfaces, wherein the incident surface is perpendicular to the light-outputting surface, each of the side surfaces is perpendicular to the incident surface and the light-outputting surface, the light-outputting surface has a plurality of micro-structures formed thereon for converging lights, and each of the side surfaces has a light-absorption material mounted thereon for absorbing lights outputted from the side surfaces; and
an LED light source mounted beside the incident surface of the light guide plate and being divided into at least two regions, wherein LEDs of the LED light sources in each of the regions are used to output lights to the incident surface so as to provide backlight to the pixels in the corresponding positions of the display panel via the light guide plate.

In the liquid crystal display device of the present invention, the micro-structure are a plurality of bar-shaped prisms; the bar-shaped prisms are arranged parallel to each other; each of the bar-shaped prisms has a length direction parallel to the side surfaces; and the light-absorption material is mounted near an end of the side surface far from the LED light source.

In the liquid crystal display device of the present invention, the length of the side surface where the light-absorption material is mounted occupies 10% to 50% of the total length of the side surface.

In the liquid crystal display device of the present invention, the length of the side surface where the light-absorption material is mounted occupies 10% to 20% of the total length of the side surface.

In the liquid crystal display device of the present invention, the light-absorption material is a light-absorption adhesive tape.

In the liquid crystal display device of the present invention, the light-absorption material is light-absorption printing ink.

In the liquid crystal display device of the present invention, the light-absorption material is a light-absorption adhesive tape with light-absorption printing ink.

Compared with the conventional backlight module and its corresponding liquid crystal device, the backlight module and its corresponding liquid crystal device of the present invention have simple structures, cost less and can greatly reduce brightness crosstalk and thereby solving the technical problem in which the light guide plate of the conventional backlight module has serious light leakage near a far end at a side of the light guide plate and causes a serious brightness crosstalk at the side of the light guide plate.

This invention is detailed described with reference to the following preferred embodiments and the accompanying drawings, where the aforementioned contents of this invention can be made more clear and understandable.

### BRIEF DESCRIPTION OF THE DRAWINGS

FIG. 1 is a schematic diagram of the structure of a conventional backlight module of a liquid crystal display device using an active shutter 3D display technology;

FIG. 2 is a cross-sectional view taken along the line A-A′ in FIG. 1;

FIG. 3 is a schematic diagram of the brightness distribution of a backlight module of a conventional liquid crystal display device using active shutter 3D display technology;

FIG. 4 is a curve diagram of brightness crosstalk of the backlight module of the conventional liquid crystal display device using active shutter 3D display technology;

FIG. 5 is a schematic diagram of the structure of a backlight module according to a preferred embodiment of the present invention;

FIG. 6 is a schematic diagram of the brightness distribution of the backlight module according to a preferred embodiment of the present invention; and

FIG. 7 is a curve diagram of brightness crosstalk of the backlight module according to a preferred embodiment of the present invention.

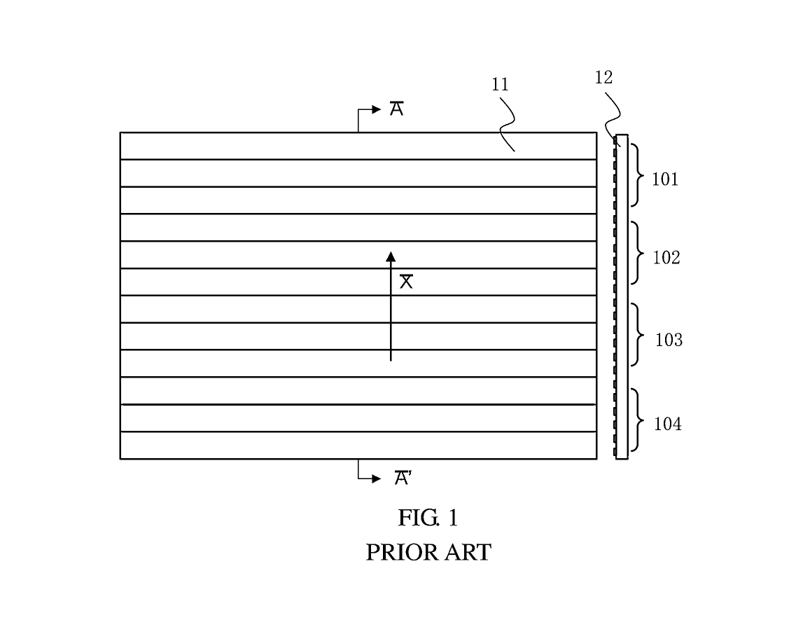

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

In the following drawings, objects in similar structure are marked by same numerals.

With reference to FIG. 3, FIG. 3 is a structural schematic view of a pixel structure according to a preferred embodiment of the present invention.

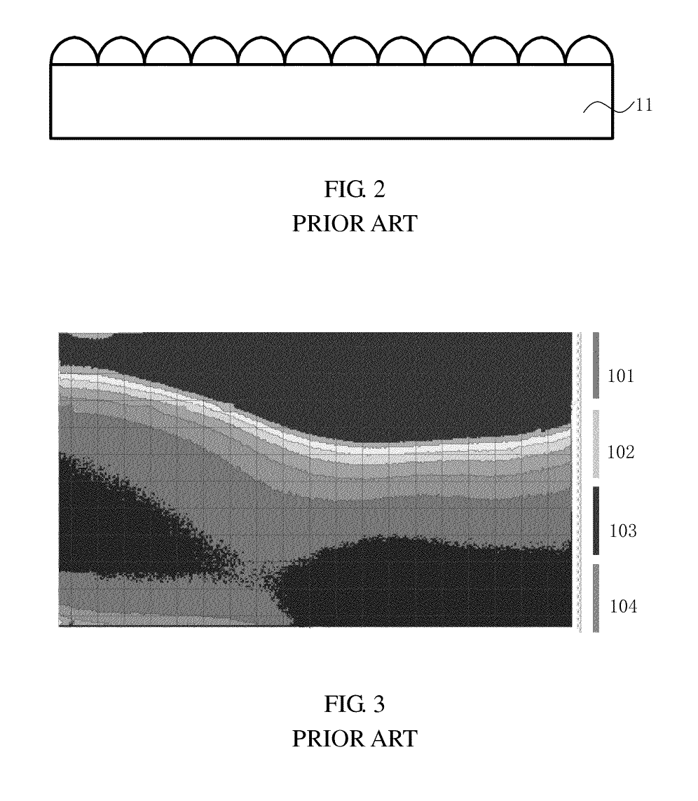

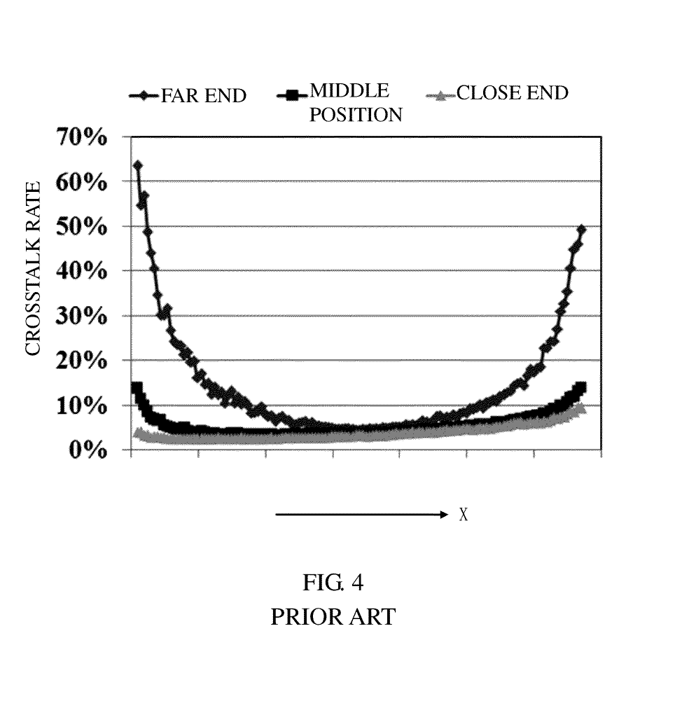

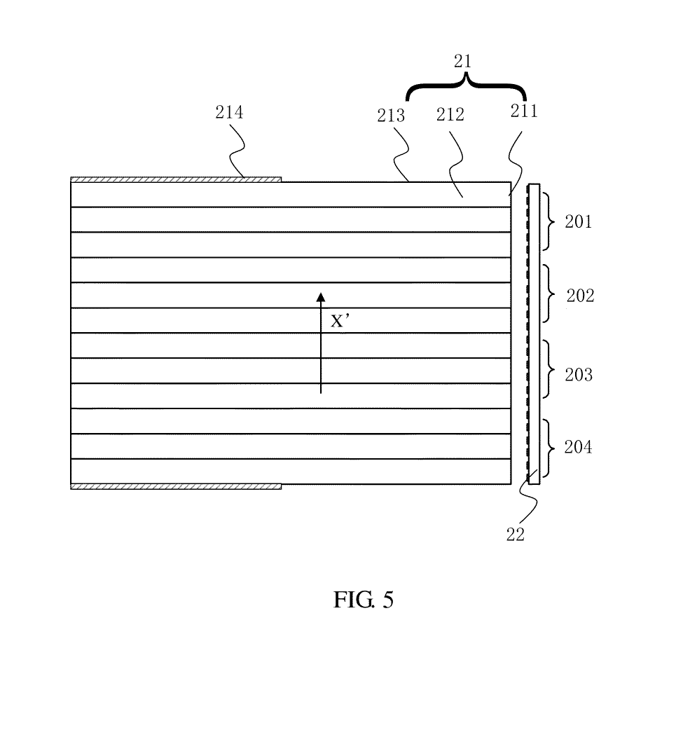

With reference to FIG. 5, FIG. 5 is a schematic diagram of the structure of a backlight module according to a preferred embodiment of the present invention. The backlight module has a backlight module 21 and an LED light source 22. The light guide plate 21 has an incident surface 211, a light-outputting surface 212 and two side surfaces 213. The incident surface 211 is perpendicular to the light-outputting surface 212. Each of the side surfaces 213 is perpendicular to the incident surface 211 and the light-outputting surface 212. The light-outputting surface 212 has a plurality of micro-structures formed thereon for converging lights (as shown in FIG. 2). The micro-structures are a plurality of bar-shaped prisms which are arranged parallel to each other, and each of the bar-shaped prisms has a length direction parallel to the side surfaces 213. The LED light source 22 is mounted beside the incident surface 211 of the light guide plate 21 and is divided into at least two regions (in FIG. 5, there are four regions: first region 201, second region 202, third region 203 and fourth region 204), wherein LEDs of the LED light source in each regions output lights to the incident surface so as to provide backlight to the pixels in the corresponding positions of the display panel from the light-outputting surface 212 of the light guide plate.

Each of the side surfaces 213 of the light guide plate 21 of the backlight module of the present invention further has a light-absorption material 214 mounted thereon for absorbing lights outputting from the side surfaces 213. The light-absorption material 214 may be a light-absorption adhesive tape (for example, a black adhesive tape), light-absorption printing ink(for example, black printing ink) or a light-absorption adhesive tape with light-absorption printing ink. The black printing ink has better effect on absorbing lights. If first attaching the light-absorption adhesive tapes to both the side surfaces 213 and then applying the light-absorption printing ink to the corresponding light-absorption adhesive tapes, it can achieve a great light-absorption effect and also avoid the diffusion of the black ink on the surfaces of the light guide plate 21.

The light-absorption material 214 is mounted near an end of each of the side surface 213 far from the LED light source 22 (also called “far end”), wherein the length of the portion of the side surface 213 where the light-absorption material 214 is mounted occupies 10% to 50% of the total length of the side surface 213, and may preferably occupy 10% to 20% of the total length of the side surface 213. Since light leakage of the side surface of the light guide plate 21 occurs at the far end of each of the side surfaces 213, the light-absorption material 214 does not need to cover all over the side surfaces 213 of the light guide plate 21, it may only heave to cover 10% to 50% of the total length of each of the side surfaces 213 of the light guide plate 21 such that it does not perform excess absorption of other lights which normally propagate inside the light guide plate. Following is the specific content of using experimental data to prove the light-absorption material 214 covering 10% to 20% of the total length of each of the side surfaces 213 of the light guide plate 21 can achieve the best effect of absorption to the light leakage at the side surfaces, therefore it is preferable that the length of the portion of the side surface 213 where the light-absorption material 214 is mounted occupies 10% to 20% of the total length of the side surface 213, which brings the greatest degree of reducing excess absorption of other lights which normally propagate inside the light guide plate.

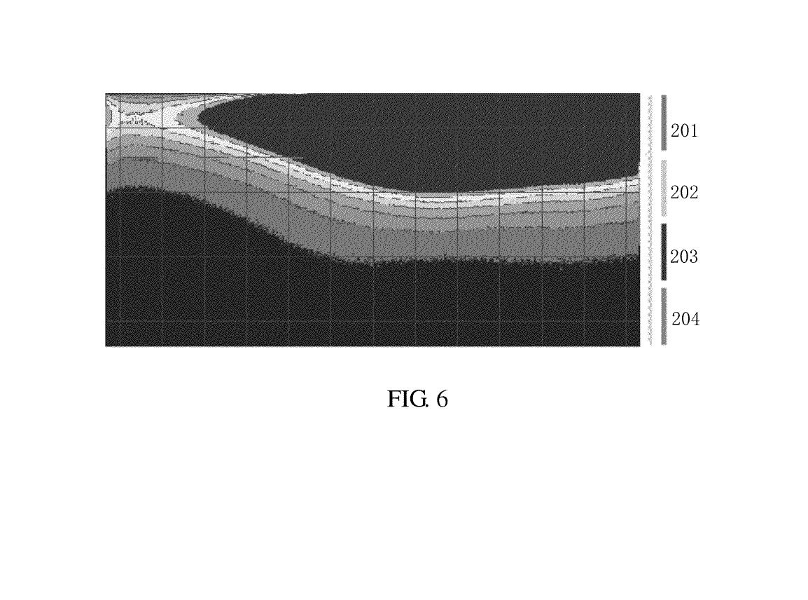

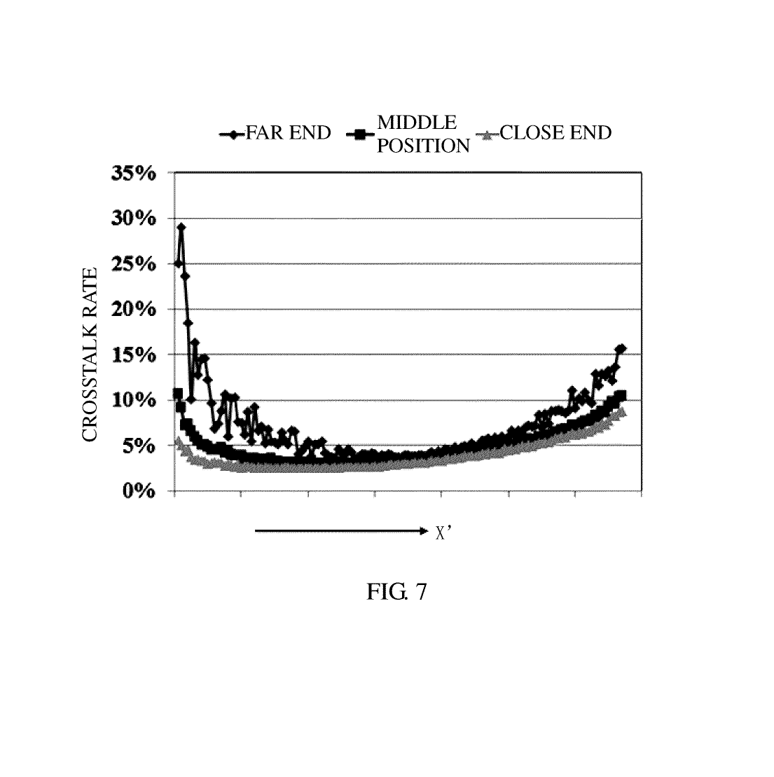

The operation of the backlight module of the present invention will be detailed described with reference to FIGS. 5 to 7. FIG. 6 is a schematic diagram of the brightness distribution of the backlight module according to a preferred embodiment of the present invention; and FIG. 7 is a curve diagram of brightness crosstalk of the backlight module according to a preferred embodiment of the present invention. When the backlight module of the present invention is in operation, the LED light source 22 is divided into a first region 201, a second region 202, a third region 203 and a four region 204. When LEDs of the LED light source 22 in the first region 201 are lit up, LEDs of the LED light sources in other regions are turned off, and the pixels in the corresponding positions of the display panel are activated in the meantime to display. Such operation principle is the same for the rest of LEDs of the LED light source 22 in other regions. In each frame, images are displayed by orderly activating the LEDs of the LED light source 22 in the regions by region and the pixels in the corresponding positions of the display panel.

FIG. 6 is a schematic diagram of the brightness distribution of the backlight module when the LEDs of the LED light source 22 in the first region 201 are lit up, and the LEDs in other regions are turned off. FIG. 7 is a curve diagram of brightness crosstalk of the backlight module when achieving active shutter 3D display. In FIG. 6, since there is a light-absorption material 214 mounted at the far end of the edge of the fourth region 204 (that is the far end of one of the side surfaces 213 of the light guide plate 21), the light guide plate has a regular distribution of brightness, that is, from the first region 201 to the fourth region 204 light intensity gradually becomes weak, and no light leakage occurs near the far end of the side surface close to the fourth region 204.

In FIG. 7, it can be seen that because no light leakage occurs near the far end of the side surface close to the fourth region 204, the crosstalk rate of brightness of the display panel corresponding to the position near the far end of the side surface of the light guide plate is greatly reduced, wherein a horizontal axis represents light-outputting positions along an X′ direction on the light-outputting surface 212 of the light guide plate 21 (as shown in FIG. 5, and the X′ direction is perpendicular to a light incident direction of the light guide plate; and a vertical axis represents the corresponding crosstalk rates at the light-outputting positions. Here, the crosstalk rate corresponding to the far end of the side surface adjacent to the fourth region 204 (in the figure it is measured at a distance of 1/9 of the length of the light guide plate from the far end, wherein the far end means the end far from the LED light source) is about half the crosstalk rate when no light-absorption material 214 is mounted (before mounting the light-absorption material, the crosstalk rate at the far end of the side surface is 65%; after mounting the light-absorption material, the crosstalk rate at the far end of the side surface is less than 30%); and the crosstalk rate corresponding to the far end of the side surface adjacent to the first region 201 is about one-third of the crosstalk rate when no light-absorption material 214 is mounted. Hence, the length of the side surface 213 where the light-absorption material 214 is mounted occupies 10% to 20% of the total length of the side surface 213 can reduce crosstalk of brightness by over 50%. When the backlight module of the present invention performs active shutter 3D display, light leakage at the far ends of the side surfaces 213 of the light guide plate 21 can be greatly reduced, and the crosstalk of brightness close to the side surface of the light guide plate 21 can be greatly reduced accordingly.

The present invention further relates to a liquid crystal display device which comprises a display panel and a backlight module. The display panel has a plurality of pixels for displaying images. The backlight module has a light guide plate and an LED light source. The light guide plate has an incident surface, a light-outputting surface and two side surfaces, wherein the incident surface is perpendicular to the light-outputting surface, and each of the side surfaces is perpendicular to the incident surface and the light-outputting surface. The light-outputting surface has a plurality of micro-structures formed thereon for converging lights, and the micro-structures are a plurality of bar-shaped prisms which are arranged parallel to each other, and each of the bar-shaped prisms has a length direction parallel to the side surfaces. The LED light source is mounted beside the incident surface of the light guide plate and is divided into at least two regions that LEDs of the LED light source in each region output lights to the incident surface so as to provide backlight to the pixels in the corresponding positions of the display panel through the light-outputting surface of the light guide plate.

Each of the side surfaces of the light guide plate of the liquid crystal display device further has a light-absorption material mounted thereon for absorbing lights outputted from the side surfaces. The light-absorption material is mounted near an end of the side surface far from the LED light source, wherein the length of the portion of the side surface where the light-absorption material is mounted occupies 10% to 50% of the total length of the side surface, and may preferably occupy 10% to 20% of the total length of the side surface.

The specific implementation for the liquid crystal display device of the present invention and its beneficial effects are the same as that of the above preferred embodiment of the backlight module, and the details are referring to the above preferred embodiments.

The backlight module of the present invention and its corresponding liquid crystal display device have simple structures, cost less and can greatly reduce the crosstalk phenomenon of brightness so that the technical problem in which the light guide plate of the conventional backlight module has serious light leakage near a far end at a side of the light guide plate and causes a serious brightness crosstalk at the side of the light guide plate is solved.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A backlight module comprising:
a light guide plate having an incident surface, a light-outputting surface and two side surfaces, wherein the incident surface is perpendicular to the light-outputting surface, each of the side surfaces is perpendicular to the incident surface and the light-outputting surface, and the light-outputting surface has a plurality of micro-structures formed thereon for converging lights; and
an LED light source mounted beside the incident surface of the light guide plate and being divided into at least two regions, wherein LEDs of the LED light sources in each of the regions are used to output lights to the incident surface so as to provide backlight to the pixels in the corresponding positions of a display panel via the light guide plate; wherein
the micro-structures are a plurality of bar-shaped prisms, and the bar-shaped prisms are arranged parallel to each other, and each of the bar-shaped prisms has a length direction parallel to the side surfaces, and each of the side surfaces has a light-absorption adhesive tape or light-absorption printing ink being mounted thereon and near an end of the side surface far from the LED light source for absorbing lights outputted from the side surface.

2. The backlight module as claimed in claim 1, wherein the length of the side surface where the light-absorption adhesive tape or light-absorption printing ink is mounted occupies 10% to 50% of the total length of the side surface.

3. The backlight module as claimed in claim 2, wherein the length of the side surface where the light-absorption adhesive tape or light-absorption printing ink is mounted occupies 10% to 20% of the total length of the side surface.

4. A backlight module comprising:
a light guide plate having an incident surface, a light-outputting surface and two side surfaces, wherein the incident surface is perpendicular to the light-outputting surface, each of the side surfaces is perpendicular to the incident surface and the light-outputting surface, the light-outputting surface has a plurality of micro-structures formed thereon for converging lights, and each of the side surfaces has a light-absorption material mounted thereon for absorbing lights outputted from the side surfaces; and
an LED light source mounted beside the incident surface of the light guide plate and being divided into at least two regions, wherein LEDs of the LED light sources in each of the regions are used to output lights to the incident surface so as to provide backlight to pixels in the corresponding positions of a display panel via the light guide plate.

5. The backlight module as claimed in claim 4, wherein the micro-structure are a plurality of bar-shaped prisms; the bar-shaped prisms are arranged parallel to each other; each of the bar-shaped prisms has a length direction parallel to the side surfaces;
and the light-absorption material is mounted near an end of the side surface far from the LED light source.

6. The backlight module as claimed in claim 5, wherein the length of the side surface where the light-absorption material is mounted occupies 10% to 50% of the total length of the side surface.

7. The backlight module as claimed in claim 6, wherein the length of the side surface where the light-absorption material is mounted occupies 10% to 20% of the total length of the side surface.

8. The backlight module as claimed in claim 4, wherein the light-absorption material is a light-absorption adhesive tape.

9. The backlight module as claimed in claim 4, wherein the light-absorption material is light-absorption printing ink.

10. The backlight module as claimed in claim 4, wherein the light-absorption material is a light-absorption adhesive tape with light-absorption printing ink.

11. A liquid crystal display device comprising:
a display panel having a plurality of pixels for display images; and
a backlight module having:
a light guide plate having an incident surface, a light-outputting surface and two side surfaces, wherein the incident surface is perpendicular to the light-outputting surface, each of the side surfaces is perpendicular to the incident surface and the light-outputting surface, the light-outputting surface has a plurality of micro-structures formed thereon for converging lights, and each of the side surfaces has a light-absorption material mounted thereon for absorbing lights outputted from the side surfaces; and
an LED light source mounted beside the incident surface of the light guide plate and being divided into at least two regions, wherein LEDs of the LED light sources in each of the regions are used to output lights to the incident surface so as to provide backlight to the pixels in the corresponding positions of the display panel via the light guide plate.

12. The liquid crystal display device as claimed in claim 11, wherein the micro-structure are a plurality of bar-shaped prisms; the bar-shaped prisms are arranged parallel to each other; each of the bar-shaped prisms has a length direction parallel to the side surfaces; and the light-absorption material is mounted near an end of the side surface far from the LED light source.

13. The liquid crystal display device as claimed in claim 12, wherein the length of the side surface where the light-absorption material is mounted occupies 10% to 50% of the total length of the side surface.

14. The liquid crystal display device as claimed in claim 13, wherein the length of the side surface where the light-absorption material is mounted occupies 10% to 20% of the total length of the side surface.

15. The liquid crystal display device as claimed in claim 11, wherein the light-absorption material is a light-absorption adhesive tape.

16. The liquid crystal display device as claimed in claim 11, wherein the light-absorption material is light-absorption printing ink.

17. The liquid crystal display device as claimed in claim 11, wherein the light-absorption material is a light-absorption adhesive tape with light-absorption printing ink.
